(19) United States
(12) Patent Application Publication
(10) Pub. No.: US 2011/0176025 A1
(43) Pub. Date: Jul. 21, 2011

(54) VIDEO INFORMATION PROCESSING APPARATUS, VIDEO INFORMATION PROCESSING METHOD, AND COMPUTER-READABLE STORAGE MEDIUM

(75) Inventor: Mahoro Anabuki, Yokohama-shi (JP)

(73) Assignee: CANON KABUSHIKI KAISHA, Tokyo (JP)

(21) Appl. No.: 13/007,489

(22) Filed: Jan. 14, 2011

(30) Foreign Application Priority Data
Jan. 20, 2010 (JP) 2010-010190

(51) Int. Cl. H04N 5/228

(52) U.S. Cl. 348/222.1; 348/E05.031

(57) ABSTRACT

A video information processing apparatus includes a setting unit configured to set an event related to a real space where a user exists, an imaging unit configured to capture a video image of the real space, a recognition unit configured to recognize the event related to the real space based on the video image, a determination unit configured to determine whether the recognized event is permitted to be presented to another person different from the user based on whether the recognized event corresponds to the event which has been set, and a transmission unit configured to transmit information of the event whose presentation to the another person is determined to be permitted.

### BACKGROUND OF THE INVENTION

1. Field of the Invention

The present invention relates to a video information processing apparatus, a video information processing method, and a computer-readable storage medium. More particularly, the present invention relates to an apparatus and a method useful for presenting an event after permission is given by a user being a presentation source in a system used for presenting an event of one place to another remote place.

2. Description of the Related Art

Remote communication using video images is being used nowadays. For example, conferencing systems dedicated to conferences between remote communication offices are realized. Further, a simple and convenient video chat application using a web camera and a network-connected personal computer (PC) is widely used as a communication tool for people who live away from one's family or close friends.

Regarding video image remote communication that connects general living spaces, a user may want to remove the things the user does not want other people to see to the outside of the camera field before starting the communication.

However, as is when a video-phone call is made, since communication starts at the moment one user responds to a start request from the other, it is not possible to clean up the room in the camera field in advance. Thus, several techniques that provide a step between the processes of “one user requests a communication start” and “the communication starts” have been developed. In other words, a step such as “start of communication is agreed according to an event of a user on the other end” is added between the processes.

For example, Japanese Patent Application Laid-Open No. 04-076698 discusses a technique where one user requests for observation of the other user, and the presentation of the observation video image starts only when the other user agrees to the request. Further, Japanese Patent Application Laid-Open No. 11-032144 discusses a technique where a user who desires to start remote video image communication confirms the state of the other user by viewing a privacy-protected video image of the other user and determines whether to start the communication.

Furthermore, Japanese Patent Application Laid-Open No. 2002-314963 and Japanese Patent Application Laid-Open No. 2003-067874 discuss remote communication by which an event of a user is constantly presented to another user. According to this communication method, although the start of the communication is not explicitly requested by the other user, an event of the user is transmitted to the other user. In other words, since a step such as “communication start is requested and the request is agreed” is not provided, the above-described publicly known techniques cannot be applied.

In remote communication, if events are expressed by video images, an event which the user does not want other people to see may be disclosed. Even if the technique discussed in Japanese Patent Application Laid-Open No. 2004-287539 is used and the event is presented by text (operation name) instead of a video image, if the expressed content is concrete, the content of the event, which the user does not want other people to know, will be disclosed. In other words, even if publicly known techniques are used, privacy is not fully protected with respect to such type of remote communication.

Thus, with respect to remote communication where an event of a user is constantly presented to another user without an explicit request for starting communication, the conventional techniques do not offer enough privacy protection for the user whose event is presented to the other user. Further, the conventional techniques are not useful in controlling the extent to which the event of a user is disclosed to another.

### SUMMARY OF THE INVENTION

The present invention is directed to a technique useful for protecting privacy of a user by presenting only an event which the user permits, selectively or partially, according to the user's determination to another user in a remote place in a constant manner.

According to an aspect of the present invention, a video information processing apparatus includes a setting unit configured to set an event related to a real space where a user exists, an imaging unit configured to capture a video image of the real space, a recognition unit configured to recognize the event related to the real space based on the video image, a determination unit configured to determine whether the recognized event is permitted to be presented to another person different from the user based on whether the recognized event corresponds to the event which has been set, and a transmission unit configured to transmit information of the event whose presentation to the another person is determined to be permitted.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a video information processing apparatus according to a first exemplary embodiment of the present invention.

FIG. 2 is a flowchart illustrating processing of the video information processing apparatus according to the first exemplary embodiment.

FIG. 3 illustrates a configuration of the video information processing apparatus according to a second exemplary embodiment of the present invention.

FIG. 4 is a flowchart illustrating processing of the video information processing apparatus according to the second exemplary embodiment.

FIG. 5 illustrates a configuration example of a computer.

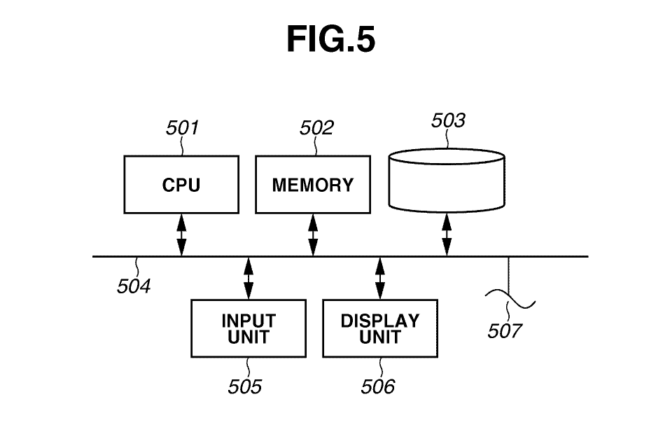

### DESCRIPTION OF THE EMBODIMENTS

Various exemplary embodiments, features, and aspects of the invention will be described in detail below with reference to the drawings.

A video information processing apparatus according to a first exemplary embodiment of the present invention recognizes an event of a real space where a first user can exist, automatically confirms whether presentation permission corresponding to the recognition result exists, and presents information of the event to a real space where a second user exists. If presentation permission which corresponds to the recognition result does not exist, setting of presentation permission corresponding to the event is requested and learning is performed. The event according to the present embodiment is an event concerning a person or environment in a real space. For example, the event is presence/absence of a person in the real space, position or identification of the person, movement, facial expression, posture, motion, or action of the person in the real space, brightness or temperature of the real space, or presence/absence or movement of an object in the real space.

Now, a configuration and processing of the video information processing apparatus of the present exemplary embodiment will be described with reference to the drawings described below.

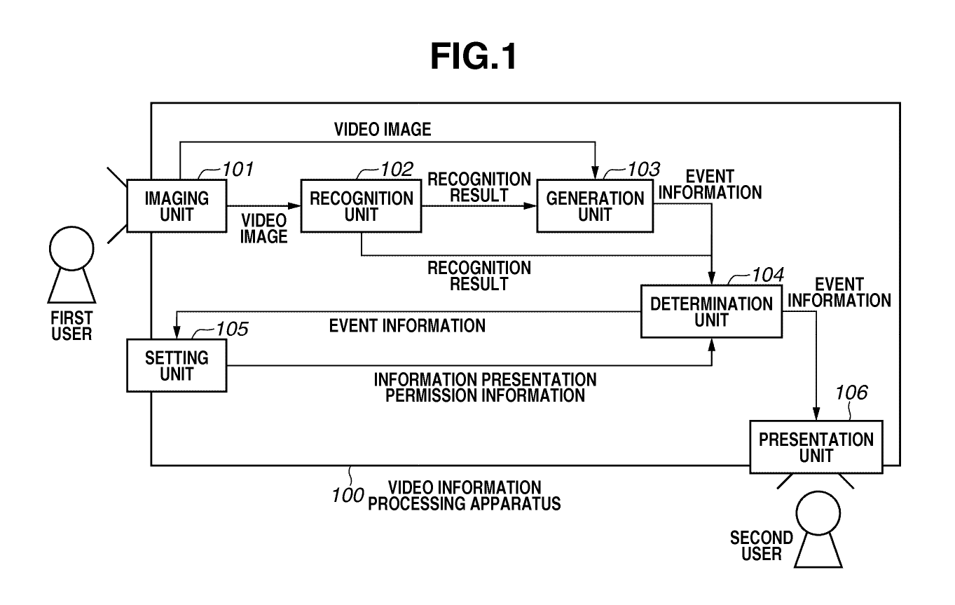

FIG. 1 illustrates a configuration of a video information processing apparatus 100 according to the present embodiment. As illustrated in FIG. 1, the video information processing apparatus 100 includes an imaging unit 101, a recognition unit 102, a generation unit 103, a determination unit 104, a setting unit 105, and a presentation unit 106. Further, if the presentation unit 106 is located at a remote site, a transmission unit 107 (not shown) that transmits data to the presentation unit 106 is further included in the video information processing apparatus 100. According to the present embodiment, a first user is the presentation source of an event and a second user is the presentation destination to which the event is presented.

The imaging unit 101 captures a video image of a real space where the first user can exist. The imaging unit 101 is, for example, a camera hanging from a ceiling, set on a floor or a table, or a built-in camera in a television set or a cellular phone. Further, the real space is, for example, a living room of a house of the first user. The captured video image is output to the recognition unit 102 and the generation unit 103.

The recognition unit 102 receives the video image transmitted from the imaging unit 101 and recognizes the event in the video image. For example, the recognition unit 102 recognizes whether a person is present/absent and the environment. If the person is present, the recognition unit 102 recognizes the position, the posture, and the movement of the person. A method used for the recognition is described below.

Recognition of a person being the recognition object is realized by detection of, for example, an image feature originating from the first user (or a person's face or head) from a video image captured by the imaging unit 101. Histograms of Oriented Gradients (HOG), which is a feature descriptor of a histogram of gradient directions in localized portions of an image can also be used as the image feature. An image feature originating from a person can also be identified by collecting a large number of video images of people and statistically learning the feature quantity common in the images by using, for example, an algorithm called boosting. If an image feature originating from a certain person is included in a video image captured by the imaging unit 101, it is recognized that “the person is at the position where the feature has been detected”.

A person's posture is recognized by, for example, detecting an image feature originating from the person's body parts with respect to the video image which is recognized that the person is included. Since the detection method is similar to that of the above-described detection of a person, the description is not repeated. If a plurality of body parts (e.g., head, shoulders, hips, knees, and toes) are detected, the posture of the person in the video image is recognized according to the relation of the detected positions of the parts.

For example, if the detected positions of the head, the shoulders, and the hips are on a straight line and if the detected positions of the knees and the toes are a predetermined distance apart with respect to the straight line in a direction which the face is facing and, further, if the straight line that connects the detected positions of the knees and the toes is approximately parallel to the straight line that connects the detected positions of the head, the shoulders, and the hips, then the person is recognized as “sitting on a chair or the like with the knee in flexion”.

A person's action is recognized by, for example, using the time and the date when the processing is performed and the results of the above-described “recognition of a person's position” and “recognition of a person's posture”. In other words, a person's action is recognized by determining a portion of the video image captured by the imaging unit 101 at which a person has been detected, the posture of that person, and the time when the video image has been captured.

For example, if a person is detected somewhere around a dining table in a video image captured by the imaging unit 101 (the position of the dining table in the video image is to be determined in advance by calibration) and if the person is sitting on a chair with the knee in flexion facing toward the center of the table, and the time is 7 p.m., then the scene can be interpreted as “a person is sitting at a dining table at 7 p.m. being dinner time” from the obtained results. Accordingly, it is determined that the probability of the person having a meal will be high. Thus, it is recognized that the scene is “a person is having a meal”. At this time, if a plurality of persons is detected and each person's posture is similar, then it is recognized that the scene is “family members are having a meal”.

Similarly, if a person is detected at an entrance at, for example, 6 p.m. and, according to the detected positions, the person moves toward the center of the house, it is recognized that “someone has come home”. Further, for example, if a person is continuously detected for a fixed period of time from 8 p.m. on a sofa in a living room, and if it is recognized that the person is facing a TV, then it is recognized that “a person is watching TV”. By drawing up a list of a combination of time, a person's position and posture, and an action recognition result corresponding to each combination in advance, a plurality of actions is recognized.

Further, a person is recognized as moving at X meters per second or moving his hand at X meters per second from the variation of the detected positions of the person or from the change in the result of the person's postures. Thus, a quantitative value can be output as a recognition result.

The recognition object of the recognition unit 102 can be a physical object as well as a person. In other words, a position and orientation of a physical object can also be used in the recognition. According to a recognition result of a physical object and time and date, an event of an environment is recognized. For example, if many objects are detected in a video image captured by the imaging unit 101 in the daytime, then it is recognized that “the room is messy”. If the video image is captured at night, then it may be recognized that “the room has been ransacked by a burglar”. If the orientation of a door with respect to the wall is parallel, then it is recognized that “the door is closed”. If the orientation of the door with respect to the wall is not parallel, then it is recognized that “the door is open”. Further, the recognition is based not only on physical objects. For example, an overall brightness of the video image captured by the imaging unit 101 can be used in determining whether the light is turned on/off.

The result of the recognition obtained according to the above-described methods is transmitted to the generation unit 103 and the determination unit 104.

The generation unit 103 generates information of an event of the first user, which is also referred to as “event information”, using the video image captured by the imaging unit 101 and the recognition result obtained by the recognition unit 102. The event information is, for example, a sentence such as time information added to text of the recognition result (e.g., “X was done (recognition result) at XX day, YY month, Z hours ZZ minutes”) superposed on the video image captured by the imaging unit 101. The text portion of the recognition result alone can be set as the event information. Further, in place of text, an icon including a combination of an icon prepared in advance for each recognition result (e.g., a graphic symbol of a plate for a recognition result of “during a meal”) and an icon representing time information (e.g., a graphic symbol of an analog clock) can be used as the event information.

Additionally, a binary change pattern prepared for each recognition result can also be used as the event information. The recognition result is, for example, expressed by a blinking of light. A plurality of pieces of event information can be generated for one event. For example, three types of event information, which are event information expressed by superposing text information on a video image, event information expressed only by text, and event information expressed only by an icon, can be generated for one event. The event information generated by the generation unit 103 is transmitted to the determination unit 104.

The determination unit 104 stores information-presentation permission information indicating whether the first user permits the presentation of the event information corresponding to the recognition result to a user other than the first user for each recognition result transmitted from the recognition unit 102. The permission information of each event, in other words, the recognition result, is selected or set in advance by the first user. Then, when the determination unit 104 receives the event information from the generation unit 103, the determination unit 104 determines whether the event information is to be output to the presentation unit 106 based on the information-presentation permission information corresponding to the recognition result transmitted from the recognition unit 102.

For example, the determination unit 104 stores information-presentation permission information such as “any type of event information can be presented” with respect to a recognition result such as “family members including the first user are having a meal”. Further, for example, the determination unit 104 stores information-presentation permission information such as “event information can be presented if it consists only of text” with respect to a recognition result such as “first user started to watch TV”. Furthermore, for example, the determination unit 104 stores information-presentation permission information such as “presentation of any type of event information is not permitted” with respect to a recognition result such as “first user has come home”. With respect to the recognition result being “first user has come home”, information-presentation permission information such as “event information can be presented if it does not include time information (of when the person has come home)” may also be stored.

A pair of such a recognition result and information-presentation permission information corresponding to the recognition result is stored, for example, in a list form in the determination unit 104. If information-presentation permission information permitting presentation is stored in the determination unit 104 with respect to the event information transmitted from the generation unit 103, the event information is transmitted to the presentation unit 106. If a plurality of pieces of event information is generated by the generation unit 103 with respect to one recognition result and the plurality of pieces of event information is transmitted to the determination unit 104, and further, if information-presentation permission information that permits presentation of a plurality of pieces of event information included in the event information which has been transmitted is set, the event information with the largest information amount is transmitted to the presentation unit 106. At that time, if the presentation unit 106 is at a remote site, the information is transmitted to the presentation unit 106 by the transmission unit 107 (not shown).

The information amount can be compared by using, for example, data amount of the event information. Generally, information amount of event information including a video image is large as its data amount is large and information amount of event information expressed only by a text is small as its data amount is small. Further, information amount of event information expressed by a blinking of light is generally furthermore smaller. The information amount can be compared by using this tendency. Further, the information amount can be reduced according to circumstances. For example, if the event information is a video image, the information amount can be reduced by using mosaic. Furthermore, if information-presentation permission information is not set or insufficient with respect to the event information transmitted from the generation unit 103, the determination unit 104 transmits the event information to the setting unit 105 and instructs the setting unit 105 to send a request for information-presentation permission information corresponding to the event information.

The setting unit 105 requires the first user to set whether presentation of event information corresponding to each recognition result which can be output by the recognition unit 102 to the second user can be permitted. Such an event permitted by the first user is called as a permitted event in the description below. Further, information used for designating whether an event corresponding to a certain recognition result is a permitted event or not is called information-presentation permission information. The setting unit 105 presents the first user with a list of possible recognition results and examples of event information corresponding to the recognition results via a speaker or a display to encourage the first user to make settings concerning the permitted event so that the first user sets the information-presentation permission information. As an example of event information corresponding to the recognition result, event information actually generated in the past by the generation unit 103 can also be presented. Further, at that time, history of the permitted events set in the past can simultaneously be presented.

When the first user receives the list of the presented recognition results, the examples of the corresponding event information, and the examples of the permitted event, the first user determines whether the event information corresponding to each recognition result is a permitted event which can be presented to the second user. The determination result is set as information-presentation permission information by a mouse, a keyboard, a touch panel, a microphone, or a camera.

If an event corresponding to a certain recognition result is set as a permitted event used for permitting presentation of event information to the second user without limitation, the information-presentation permission information will be “presentation of any type of event information corresponding to the recognition result is permitted”. If presentation of the event information to the second user is permitted with conditions, the information-presentation permission information will be “presentation of event information corresponding to the recognition result is permitted so long as the event information is in a form corresponding to the information-presentation permission information designated by the first user using the setting unit 105”. If presentation of the event information to the second user is not permitted, then the information-presentation permission information will be “presentation of event information corresponding to the recognition result is not permitted”. The information-presentation permission information which has been set is transmitted to the determination unit 104.

The setting of the information-presentation permission information via the setting unit 105 can be set by the first user at an arbitrary point in time. In other words, the information-presentation permission information corresponding to an arbitrary recognition result can be updated, deleted, or added by the first user using the setting unit 105 at any time. If the recognition unit 102 recognizes a certain event and if information-presentation permission information corresponding to the recognition result is not set at that time, the first user may be encouraged to set the information-presentation permission information via the setting unit 105.

The information-presentation permission information can be individually set for each recognition result that can be output by the recognition unit 102. However, the information-presentation permission information can also be set at a time by grouping the recognition results. The setting method is similar to the operation performed when a security level of access via the Internet is controlled. In other words, the first user selects the privacy level with respect to other users from a plurality of levels such as “high”, “middle”, and “low” at an arbitrary point in time by using a graphical user interface (GUI), a button, a gesture UI, or a speech recognition UI. Then, according to the selected level, certain information-presentation permission information is set for all the recognition results that can be output by the recognition unit 102.

For example, if the selected level is “high”, then information-presentation permission information such as “presentation is permitted if event information is expressed by text” will be set for all the recognition results. If the selected level is “low”, then information-presentation permission information such as “presentation of any type of event information is permitted so long as the event information corresponds to the recognition result” will be set for all the recognition results.

If the selected level is “middle”, with respect to a recognition result whose setting is generally set at a low privacy level (e.g., “watching TV”), information-presentation permission information such as “presentation of recognition result corresponding to any type of event information is permitted” will be set. Further, with respect to a recognition result whose setting is generally set at a high privacy level (e.g., “having a meal”), information-presentation permission information such as “presentation is permitted if event information is expressed by text”. Although setting of setting values regarding “privacy levels which are commonly set” is given here as an example, the setting level of the information-presentation permission information can be controlled according to “number of recognized persons” or “position of the recognized person”.

When the event information is transmitted from the determination unit 104, the presentation unit 106 presents the event information to a real space where the second user can exist while the first user does not exist. For example, the presentation unit 106 provides the event information including a video image to a display or a speaker, or event information including a text to an electronic display. Further, the presentation unit 106 provides event information expressed by a binary change pattern according to turn on/off of a light-emitting diode (LED) or audio event information output from a speaker.

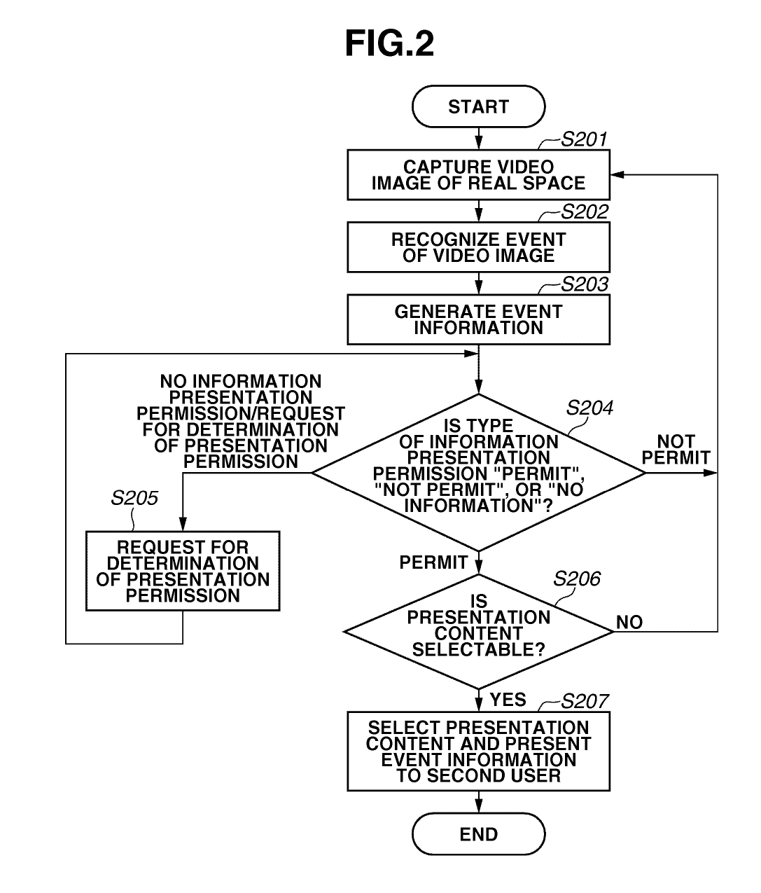

(processing) Next, the processing performed by the video information processing apparatus 100 according to the present embodiment will be described with reference to the flowchart illustrated in FIG. 2.

In step S201, the imaging unit 101 captures a video image of a real space where the first user can exist. For example, a video image of the real space is captured by a camera hanging from a ceiling, set on a floor or a table, or a built-in camera in a television or a cellular phone. The real space is, for example, a living room of a house of the first user.

The imaging unit 101 can capture a video image of the first user or continue capturing video images of the real space where the first user exists by a camera worn by the first user. If a camera is used, camera parameters such as pan, tilt, and zoom and position and posture can be changeable. The imaging unit 101 can include a sensor such as a human sensor or a temperature sensor which is used for measuring a phenomenon that can reflect an event of the real space where the first user can exist. In this case, the measurement result of the sensor is transmitted to the recognition unit 102 together with the captured video image. The captured video image is transmitted to the recognition unit 102 and to the generation unit 103, and then the processing proceeds to step S202.

In step S202, the recognition unit 102 receives the video image transmitted from the imaging unit 101 and recognizes the event of the video image. For example, the recognition unit 102 recognizes the event concerning whether a person is present/absent, a position, posture, or movement of the person if the person is present, and the environment. In other words, the recognition unit 102 outputs, as a recognition result, whether the first user is in the room, family members are having a meal, the first user has come home, started to watch TV, finished watching TV, nobody is in the room, the first user is keeping still, walking around, or sleeping.

Further, an event, which can be converted into numerical forms such as the number of persons in the real space or a position or a movement speed of each person, can also be recognized. The event recognition is realized by, for example, if it is recognition of action, forming a list of actions that can be the recognition object in advance according to the positions, motions, and extraction time of the human figure that are extracted from the video image. Then, after checking the extracted results obtained from the video image, matching objects are output as an action recognition result. If the imaging unit 101 includes a sensor, a sensing result obtained by the sensor can also be included in the recognition. The recognition unit 102 can physically be at the same site as the imaging unit 101 or in a remote server connected to the imaging unit 101 via a network. The recognition result is transmitted to the generation unit 103 and to the determination unit 104, and then the processing proceeds to step S203.

In step S203, by using the video image captured by the imaging unit 101 or the recognition result obtained by the recognition unit 102, the generation unit 103 generates event information. For example, a sentence “X was done (recognition result) at XX day, YY month, Z hours ZZ minutes”, which is obtained by combining time information and a text that expresses the recognition result, is superposed on a video image captured by the imaging unit 101.

Further, the video image captured by the imaging unit 101 can be used as it is as the event information. Furthermore, a portion concerning privacy included in a video image captured by the imaging unit 101 can also be used as the event information by a concealment process based on the video image recognition result. Additionally, animation, prepared in advance, which expresses the content of the recognition result obtained in step S202 in an easy-to-understand manner can be superposed on the video image. The event information is not limited to one type and a plurality of types of event information that expresses the same event can be used. If a plurality of types of event information is to be generated, a plurality of types of information can be generated each time or a plurality of types of event information which can be generated is generated according to a video image captured by the imaging unit 101 or a recognition result obtained by the recognition unit 102.

Further, for example, the generation unit 103 can change the event information to be generated according to accuracy of the recognition result obtained by the recognition unit 102. According to the present embodiment, the term accuracy is used for expressing an accuracy rate that the recognition unit 102 expects with respect to the recognition result. As for the general image recognition, similarity of an image pattern learned in advance and an image pattern of the recognition object is evaluated. If the similarity is high, the recognition unit 102 recognizes that image pattern of the recognition result is the same as the learned image pattern. If a person is to be recognized, characteristic patterns of the person are learned in advance from images obtained by imaging the person, and if an image pattern similar to the characteristic patterns is found in the images of the recognition object, the recognition unit 102 recognizes that the person is included in the image. If the similarity is high, then the accuracy will be high. If the similarity is low, then the accuracy will be low.

For example, since the probability of the recognition result being wrong will be higher if the obtained accuracy is low, the generation unit 103 generates event information including the video image so that the first or the second user can directly view and confirm the content of the event. On the other hand, if the accuracy of the recognition result is high, protection of privacy is given priority. Thus, event information expressed only by text, which the first or the second user is unable to confirm the content of the event by directly viewing it, is also generated. In other words, the form in which the event information is presented is determined according to the accuracy, and the event information is generated according to the determined form. The event information generated by the generation unit 103 is transmitted to the determination unit 104, and then the processing proceeds to step S204.

In step S204, the determination unit 104 confirms information-presentation permission information including information of whether the first user permits presentation of the event information corresponding to the recognition result to a person other than the first user. The determination unit 104 performs the confirmation each time it receives a recognition result transmitted from the recognition unit 102. Regarding the information-presentation permission information, for example, information such as “presentation of any type of event information is permitted” is set for a recognition result such as “family members including the first user are having a meal”. Further, information-presentation permission information such as “presentation of event information is permitted so long as it includes only text information” is set for a recognition result such as “first user started to watch TV”, and “presentation of any type of event information is not permitted” is set for “the first user has come home”. Information-presentation permission information may not be set for a certain recognition result.

In other words, in step S204, whether information-presentation permission information corresponding to the recognition result is internally stored in the determination unit 104 is confirmed. If the information-presentation permission information is internally stored, the information is set or selected before step S201. The selection or the setting method is similar to the method used in selecting or setting the information-presentation permission information described in step S206 below. In step S204, if the information-presentation permission information is not internally stored (NO INFORMATION PRESENTATION PERMISSION in step S204), the determination unit 104 transmits the event information provided from the generation unit 103 in step S203 to the setting unit 105, and the processing proceeds to step S205.

Additionally, if a fixed period of time passes from the time the information-presentation permission information has been set, even if the event is not changed, the manner that the presentation is permitted may be changed. Thus, even if information-presentation permission information with respect to the recognition result provided by the recognition unit 102 is set, if a fixed period of time passes from when the information-presentation permission information has been set, the information-presentation permission information is deleted.

Further, even if the storage of the information-presentation permission information corresponding to the recognition result is confirmed in step S204, if a fixed period of time passes from when the information-presentation permission information has been set, the determination unit 104 determines that an inquiry needs to be sent to the user. Then, the determination unit 104 transmits the event information received from the generation unit 103 in step S203 to the setting unit 105, and the processing proceeds to step S205.

Further, in step S204, if the information-presentation permission information is stored in the determination unit 104 and if the content of the information-presentation permission information does not allow the presentation (NOT PERMIT in step S204), the processing returns to step S201.

Further, in step S204, if the information-presentation permission information is stored by the determination unit 104, a fixed period of time does not pass yet and the content of the information does not include a setting that does not permit the presentation such as “presentation of any event information is not permitted” (PERMIT in step S204), then the processing proceeds to step S206.

In step S205, the setting unit 105 requests the first user to make settings necessary in permitting or not permitting presentation of the event information corresponding to the recognition result obtained in step S202. If the event is a permitted event, then the setting necessary in the presentation of the event information to the second user is requested. The first user makes the setting by a mouse, a keyboard, a microphone, or a user interface for data setting of a camera. At that time, the event information transmitted from the determination unit 104 can be presented to the first user via a speaker or a display.

For example, if the setting unit 105 receives one type of event information from the determination unit 104, the setting unit 105 presents the first user with that information or a simplified version of the information and then displays a message such as “Permit presentation of this event information to the second user?”. If the setting unit 105 receives a plurality of types of event information from the determination unit 104, then the setting unit 105 presents the first user with respective simplified versions of the plurality of types of event information arranged and displayed, or presented one by one in order, and then displays a message such as “Which type of event information can be presented to the second user?”.

A response made by the first user with respect to such a request is made by a mouse, a keyboard, a microphone, or a user interface for data setting of a camera and then received by the setting unit 105. If necessary, the setting unit 105 interprets the response made by the first user by using a speech recognition technique or a gesture recognition technique and sets the obtained result as the information-presentation permission information. For example, if the first user performs a mouse operation or a key input that is interpreted as permitting the presentation, it is determined as information-presentation permission information such as “presentation of any type of event information is permitted”.

If the first user selects apart of the presented event information and performs a mouse operation or a key input that can be interpreted as permitting the presentation, the setting unit 105 obtains information-presentation permission information such as “event information can be presented if it is of the same type as the selected event information”. For example, if words spoken by the first user or a bodily motion of the first user is interpreted as not permitting the presentation according to a speech recognition technique or a gesture recognition technique, then the setting unit 105 receives information-presentation permission information such as “presentation of any type of event information is not permitted”. On receiving such information-presentation permission information, the setting unit 105 transmits the information to the determination unit 104, and then the processing returns to step S204. If the information-presentation permission information is not set by the first user even after a fixed period of time, then, although not shown in FIG. 2, the processing returns to step S201.

In step S206, the determination unit 104 selects the output content of the event information based on the information-presentation permission information. In other words, the type of event information whose presentation is permitted and included in the information-presentation permission information is checked against the type of event information transmitted from the generation unit 103 to the determination unit 104, and one type of event information is selected from the matching information. If only one type of matching information is detected, then that information will be selected.

A case where one type of event information is transmitted from the generation unit 103 to the determination unit 104 and the information-presentation permission information is “presentation of any type of event information is permitted” corresponds to this case. Additionally, a case where the information-presentation permission information is “presentation of event information is permitted if it is of a certain type” and the certain type of event information is included in the event information transmitted from the generation unit 103 to the determination unit 104 corresponds to this case.

If a plurality of types of matching event information is detected with respect to the type of the event information transmitted to the determination unit 104 and the type of event information included in the information-presentation permission information, then one type is selected according to some kind of criterion. A case where a plurality of types of event information is transmitted from the generation unit 103 to the determination unit 104 and the content of the information-presentation permission information is “presentation of any type of event information is permitted” corresponds to this case. The criterion for the selection is not limited but it may be useful if the selection is made according to the information amount. In either case, if one type of event information is selected (YES in step S206), the selected type of event information is transmitted to the presentation unit 106, and the processing proceeds to step S207.

If no matching type of event information is detected with respect to the type of the event information transmitted to the determination unit 104 and the type of event information included in the information-presentation permission information (NO in step S206), the event information will be unselectable, and the processing returns to step S201. A case where the content of the information-presentation permission information is “presentation of any type of event information is not permitted” corresponds to this case. Further, a case where the content of the information-presentation permission information is “presentation of event information is permitted if it is of a certain type” and no event information of that type is included in the event information transmitted from the generation unit 103 to the determination unit 104 corresponds to this case.

Further, if no matching type of event information is included in the event information of the information-presentation permission information, the processing proceeds not to step S201 but to step S205. Then, the first user is requested again to make settings regarding whether presentation of the event information generated in step S203 to the second user can be permitted.

In step S207, when the event information is transmitted from the determination unit 104, the presentation unit 106 presents the event information to a real space where the second user can exist. For example, the presentation unit 106 provides a display or a speaker with event information including a video image, provides an electronic display with event information expressed by a text or turn on/off of a LED light. When the event information transmitted from the determination unit 104 is presented on the presentation unit 106, the processing returns to step S201.

According to the processing described above, the video information processing apparatus 100 recognizes the video image of the real space where the first user can exist and automatically confirms whether presentation permission corresponding to the recognition result exists. If such presentation permission exists, information of an event of the real space where the first user can exist can be presented to the second user. The presentation permission corresponding to the recognition result is to be selected or set before the processing of the video information processing apparatus 100 starts.

The video information processing apparatus 100 can selectively select an event corresponding to the permission given by the first user and automatically transmit the selected event to the second user eliminating the inconvenience of the first or the second user. Even if the presentation permission is not selected or set in advance, if the presentation permission is selected or set once by the user, then when a similar event occurs at a later time, the user does not need to take any action. Thus, in this case also, the video information processing apparatus 100 can selectively select the event corresponding to the permission given by the first user and automatically transmit the selected event information to the second user eliminating the inconvenience of the first or the second user.

According to the present embodiment, a case where the event information is presented from the first user to the second user is described. However, the present embodiment is applicable to event information-presentation among three users or more.

The video information processing apparatus according to a second exemplary embodiment of the present invention recognizes an event of a real space where the first user can exist and, if a change in the event is detected based on a result of the recognition, determines whether presentation of the event is permitted each time the change is detected. If the presentation of the event is permitted, the video information processing apparatus presents information of the event to the second user.

A configuration and processing of the video information processing apparatus according to the present embodiment will now be described with reference to the drawings.

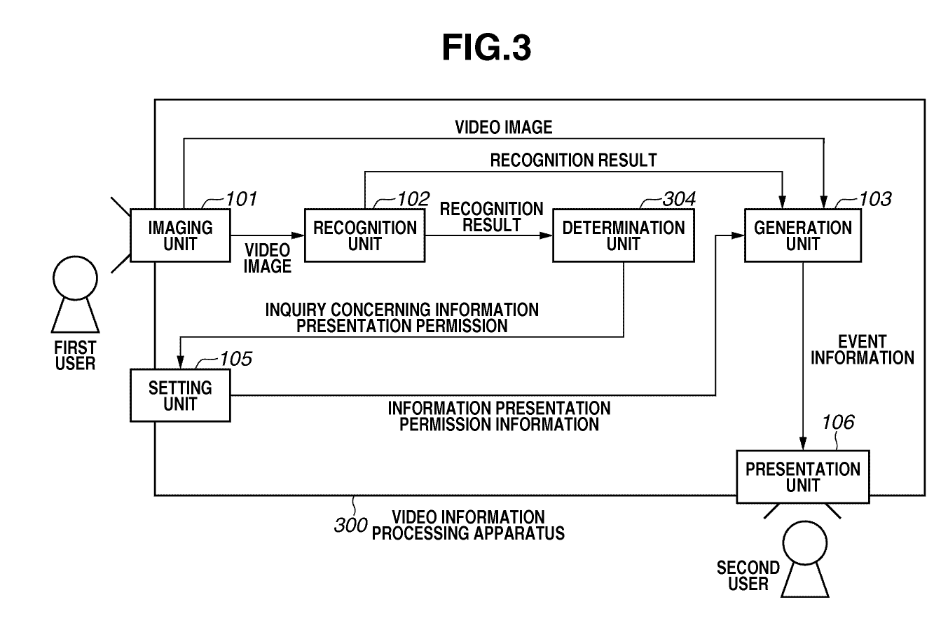

FIG. 3 illustrates a configuration of a video information processing apparatus 300 according to the present embodiment. As illustrated in FIG. 3, the video information processing apparatus 300 includes the imaging unit 101, the recognition unit 102, the generation unit 103, a determination unit 304, the setting unit 105, and the presentation unit 106. Since most of the components of the video information processing apparatus 300 are similar to those of the video information processing apparatus 100 illustrated in FIG. 1, similar portions are denoted by the same reference numerals and their descriptions are not repeated. As is with the first exemplary embodiment, the first user is the presentation source of the event and the second user is the presentation destination to which the event is presented.

The imaging unit 101 captures a video image of a real space where the first user can exist. The captured video image is transmitted to the recognition unit 102, the generation unit 103, and the determination unit 304.

The recognition unit 102 receives the video image from the imaging unit 101 and recognizes the event of the video image. The obtained recognition result is transmitted to the generation unit 103 and the determination unit 304.

The determination unit 304 receives the recognition result from the recognition unit 102 and detects a change in the event of the real space where the first user can exist. For example, if the recognition result is continuously transmitted from the recognition unit 102 one by one, if the received recognition result is changed, the fact that the recognition result is changed is detected as an event change. When the event change is detected, inquiry concerning information-presentation permission information corresponding to the event after the change as well as a video image of the event, a recognition result of the event or both of them are transmitted to the setting unit 105.

When the setting unit 105 receives the inquiry concerning the information-presentation permission information from the determination unit 304, the setting unit 105 confirms whether the information-presentation permission information set for the event being the object of the inquiry is stored in the setting unit 105. Then, if information-presentation permission information corresponding to a video image, a recognition result or both of them transmitted from the determination unit 304 or information-presentation permission information corresponding to a similar event is stored, then the stored information-presentation permission information is transmitted to the generation unit 103 as the information permission presentation information.

For example, with respect to an event such as “first user and Mr. B being a family member of the first user are having a meal”, if information-presentation permission information such as “presentation of any type of event information is permitted” is set and internally stored, and if a presentation permission inquiry with respect to “first user and Mr. C being a family member of the first user are having a meal” is transmitted, then the setting unit 105 autonomously transmits information-presentation permission information such as “presentation of any type of event information is permitted” to the generation unit 103. In this way, each time the determination unit 304 detects a change in the event, whether the presentation of the event is permitted or not permitted to the second user is determined based on certain information-presentation permission information without the first user taking an action.

Further, if information-presentation permission information corresponding to the event being the object of the inquiry or to a similar event is not stored in the setting unit 105, the setting of the information-presentation permission information is requested to the first user. For example, an inquiry such as “which presentation form (video image, text, or light pattern) is acceptable when the current event is presented to the second user?” is given to the user. At that time, a video image, a recognition result or both of them that indicate the event sent from the determination unit 304 are presented to the first user. When the setting unit 105 obtains the setting that indicates which of the presentation forms is allowed by the first user regarding the presentation of the event from the first user, the obtained setting is stored in the setting unit 105 as new information-presentation permission information and also transmitted to the generation unit 103.

The generation unit 103 generates event information using the video image captured by the imaging unit 101 and the recognition result obtained from the recognition unit 102 based on the information-presentation permission information transmitted from the setting unit 105. For example, the generation unit 103 generates information that matches various presentation forms (text, video image, and light pattern) for the same event. Then, the generated event information is transmitted from the transmission unit 107 (not shown) to the presentation unit 106. When the event information is transmitted, the presentation unit 106 presents the event information to a real space where the second user can exist.

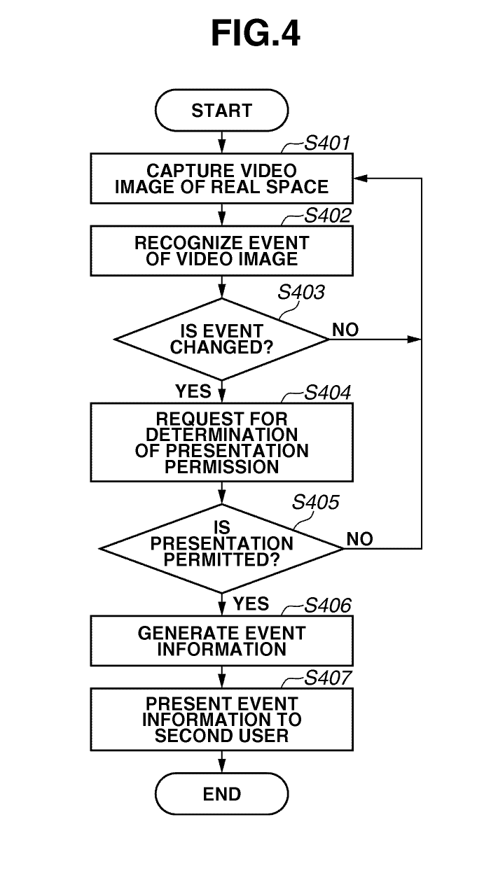

The processing performed by the video information processing apparatus 300 of the present embodiment will now be described with reference to the flowchart illustrated in FIG. 4.

In step S401, the imaging unit 101 captures a video image of a real space where the first user can exist. The captured video image is output to the recognition unit 102, the generation unit 103, and the determination unit 304, and then the processing proceeds to step S402.

In step S402, the recognition unit 102 receives the video image sent from the imaging unit 101 and recognizes the event of the video image. The recognition result is transmitted to the generation unit 103 and the determination unit 304, and then the processing proceeds to step S403.

In step S403, the determination unit 304 detects a change in the event using the recognition result obtained in step S402. The determination unit 304 detects the change by detecting whether a past event and a newly recognized event are the same. If a recognition result is not received in the past, the determination unit 304 internally stores the result, and the processing returns to step S401. If a recognition result is received in the past, the recognition result obtained in step S402 is examined against the history of the received recognition results, and whether a change in the event has occurred is detected. If a change in the event is not detected (NO in step S403), the processing returns to step S401. If the change in the event is detected (YES in step S403), the processing proceeds to step S404.

For example, if a plurality of recognition results is transmitted from the recognition unit 102, and if the rate of the recognition results that is changed is higher than a certain rate with respect to the received recognition results, then the event is detected as an event change. Further, the “event change” can be explicitly defined in advance. In other words, by determining a certain rule in advance, for example, it is determined that the event change has occurred “when the recognition result changes from A to B” or “when recognition result C is obtained”. On the other hand, it is determined that the event is not changed “when the recognition result changes from B to A” or “when the recognition result changes from C to a different recognition result”. The event detection can be performed according to such a rule.

If the recognition result is qualitative (e.g., a recognition result indicating that the user is “having a meal” or “relaxing”), the change in the value can be used as an index of the event change. Further, if the recognition result is quantitative (e.g., “moving at X meters per second” or “moving hands at X meters per second”), the change in degrees (i.e., differential value of the recognition result) in a certain reference time will be the index of the event change.

According to the method described above, if appropriate state detection is realized, for example, it is possible to make such settings that if the state changes between two events in a short time or a the state is a quantitatively slight change in event, it is not determined as a “change in event”. In this way, practical detection of the change in event can be realized. The determination unit 304 detects an event change in the real space where the first user can exist based on the history of the received recognition results obtained from the recognition unit 102. If the event change is detected, the determination unit 304 transmits a presentation permission confirmation signal and a video image presenting the event, a recognition result or both of them to the setting unit 105, and then the processing proceeds to step S404.

In step S404, the setting unit 105 confirms the information-presentation permission information with respect to a video image, a recognition result or both of them transmitted from the determination unit 304 or information-presentation permission information corresponding to a similar event. If information-presentation permission information corresponding to a video image, a recognition result or both of them transmitted from the determination unit 304 or information-presentation permission information corresponding to a similar event is stored, then the stored information-presentation permission information is transmitted to the generation unit 103 as the information permission presentation information.

If information-presentation permission information corresponding to the event being the object of the inquiry or to a similar event is not stored in the setting unit 105, the setting of the information-presentation permission information is requested to the first user. For example, an inquiry such as “which presentation form (video image, text, or light pattern) is acceptable if the current event is presented to the second user?” is given to the user. At that time, a video image, a recognition result or both of them that indicate the event sent from the determination unit 304 are presented to the first user. When the setting unit 105 obtains the setting that indicates which of the presentation forms is allowed by the first user regarding the presentation of the event from the first user, the obtained setting is transmitted to the generation unit 103, and the processing proceeds to step S405.

In step S405, the determination unit 104 confirms the information-presentation permission information which has been set. If the content indicates that “presentation of the current event is not permitted” (NO in step S405), the processing returns to step S401. If the content indicates that the presentation of the current event is permitted (YES in step S405), the processing proceeds to step S406.

In step S406, based on the information-presentation permission information received from the setting unit 105, the generation unit 103 generates event information using the video image captured by the imaging unit 101 and the recognition result obtained from the recognition unit 102. For example, the generation unit 103 generates information according to various presentation forms (text, video image, and light pattern), and then the processing proceeds to step S407.

In step S407, when the event information is transmitted from the determination unit 104, the presentation unit 106 presents the event information to a real space where the second user can exist while the first user does not exist, and then the processing returns to step S401.

According to the above-described processing, the video information processing apparatus 300 recognizes a video image of the real space where the first user can exist. Based on the recognition result, each time a change in event is detected, the first user is asked whether the presentation permission is appropriate, and information of an event of the real space where the first user can exist is presented to the second user. Although the event in a real space changes from moment to moment, the video information processing apparatus 100 asks the first user whether the presentation permission is appropriate each time the event changes. In this way, an event which the first user does not want the second user to know is not presented to the second user without the first user knowing it. Further, if the “detection method of the event change” can be appropriately set, it helps avoid the first user from being asked to respond to the inquiry regarding presentation permission.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-010190 filed Jan. 20, 2010, which is hereby incorporated by reference herein in its entirety.

What is claimed is:

1. A video information processing apparatus comprising:
a setting unit configured to set an event related to a real space where a user exists;
an imaging unit configured to capture a video image of the real space;
a recognition unit configured to recognize the event related to the real space based on the video image;
a determination unit configured to determine whether the recognized event is permitted to be presented to another person different from the user based on whether the recognized event corresponds to the event which has been set; and
a transmission unit configured to transmit information of the event whose presentation to the another person is determined to be permitted.

2. The video information processing apparatus according to claim 1, wherein when the recognized event is changed, the determination unit determines whether the recognized event is permitted to be presented to the another person.

3. The video information processing apparatus according to claim 1, wherein the setting unit sets the event whose presentation to the another person is permitted and, when the recognized event is changed, the determination unit determines that the recognized event corresponding to the set event is permitted to be presented to the another person.

4. The video information processing apparatus according to claim 1, further comprising a generation unit configured to generate presentation information based on the video image and the recognized event when presentation is determined to be permitted by the determination unit,
wherein the transmission unit transmits the generated presentation information as information presenting the event.

5. The video information processing apparatus according to claim 1, wherein the transmission unit transmits the video image as information presenting the event.

6. The video information processing apparatus according to claim 1, further comprising a presentation unit configured to present the transmitted presentation information to the another person.

7. The video information processing apparatus according to claim 1, wherein the event is an event of a human figure in the real space or of an environment of the real space.

8. The video information processing apparatus according to claim 1, further comprising a request unit configured to request the user to set the event.

9. The video information processing apparatus according to claim 8, wherein the request unit requests for setting of a permitted event when the recognition unit detects that the event is changed according to recognition of a new event different from the event recognized in the past.

10. The video information processing apparatus according to claim 8, wherein the request unit requests for setting of whether to set the recognized event as a permitted event if the event recognized by the recognition unit is not included in the permitted event.

11. The video information processing apparatus according to claim 8, wherein the presentation unit presents a history of the permitted event set in the past before the request unit requests for the setting of the permitted event.

12. The video information processing apparatus according to claim 1, wherein the information of the event includes a plurality of types of presentation forms.

13. The video information processing apparatus according to claim 12, wherein the plurality of types of presentation forms includes a form for presenting the captured video image and a form for presenting a text expressing the event.

14. The video information processing apparatus according to claim 12, wherein the setting unit sets a privacy level for each event which is set and the determination unit determines a form, out of the plurality of types of presentation forms, which is permitted to be used in presenting the recognized event to the another person according to the privacy level.

15. The video information processing apparatus according to claim 12, wherein the generation unit determines the presentation form according to accuracy of a recognition result by the recognition unit and generates presentation information in the presentation form.

16. The video information processing apparatus according to claim 1, wherein the recognition unit recognizes an action of a human figure based on a position and a posture of the human figure included in the video image and a time when the video image has been captured.

17. The video information processing apparatus according to claim 1, wherein the recognition unit recognizes an environment of an object based on a position and orientation of the object included in the video image and a time when the video image has been captured.

18. A video information processing method comprising:
setting an event related to a real space where a user exists;
capturing a video image of the real space;
recognizing the event related to the real space based on the video image;
determining whether the recognized event is permitted to be presented to another person different from the user based on whether the recognized event corresponds to the event which has been set; and
transmitting information of the event whose presentation to the another person is determined to be permitted.

19. A non-transitory computer-readable storage medium storing a program that causes a computer to execute the video information processing method according to claim 18.
